(19) United States
(12) Patent Application Publication
(10) Pub. No.: US 2026/0091617 A1
(43) Pub. Date: Apr. 2, 2026

(54) WHEEL END ASSEMBLY

(71) Applicant: Dana Automotive Systems Group, LLC, Maumee, OH (US)

(72) Inventors: Anthony PESCARA, Oregon, OH (US); Corey KWAPICH, Ottawa Lake, MI (US); Dustin BROOKS, Maumee, OH (US)

(21) Appl. No.: 19/325,346

(22) Filed: Sep. 10, 2025

Related U.S. Application Data
(60) Provisional application No. 63/700,326, filed on Sep. 27, 2024.

(51) Int. Cl. B60B 35/12; B60B 27/00

(52) U.S. Cl. CPC B60B 35/128; B60B 27/0042; B60B 27/0078

(57) ABSTRACT

Systems are provided for an electric drive axle, and more specifically, systems are provided for a wheel end assembly. In one example, a wheel end assembly includes a constant velocity (CV) shaft splined with a CV joint that extends through a hub and a bearing in face-sharing contact with each of a CV joint shoulder and a hub shoulder.

### CROSS REFERENCE TO RELATED APPLICATIONS

The present application claims priority to U.S. Provisional Application No. 63/700,326, entitled “WHEEL END ASSEMBLY”, and filed on September 27, 2024. The entire contents of the above-listed application are hereby incorporated by reference for all purposes.

### TECHNICAL FIELD

The present description relates generally to a wheel end assembly integrated with a constant velocity (CV) joint assembly.

### BACKGROUND AND SUMMARY

Existing wheel end assemblies utilize various components to achieve bearing retention and wheel retention. The various components integrated within existing wheel end assemblies may include a support bearing for a constant velocity (CV) shaft, an adapter configured for a hub, and a CV shaft, sealing components, and fasteners. Each of the various components used for bearing retention and wheel retention in the wheel end assemblies may introduce complexity and the potential for assembly and service errors.

US 11,124,020 B2 to Choi et. al discloses CV joint assembly integrated with a wheel hub device. The CV joint assembly includes an internal race coupled to an end portion of a driveshaft. A hub housing is coupled to the internal race to position joint balls therein and includes a bearing coupled to an external circumferential surface of the hub housing. A knuckle carrier is coupled to an external ring of the bearing. A lock nut is coupled to the hub housing and engaged with an internal ring of the bearing to apply a preload to the internal ring. A lock ring is coupled to the hub housing abutting against a side surface of the lock nut, and a plurality of fasteners that couple the lock nut and the lock ring. Including the lock ring and the fasteners may still introduce the potential for assembly and service errors, while increasing a cost of the CV joint assembly.

In one example, the issues described above may be addressed by a wheel end assembly including a constant velocity (CV) shaft splined with a CV joint that extends through a hub and a bearing in face-sharing contact with each of a CV joint shoulder and a hub shoulder.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 is a schematic diagram of a vehicle driveline is shown.

FIG. 2 shows a cross section of a wheel end assembly.

### DETAILED DESCRIPTION

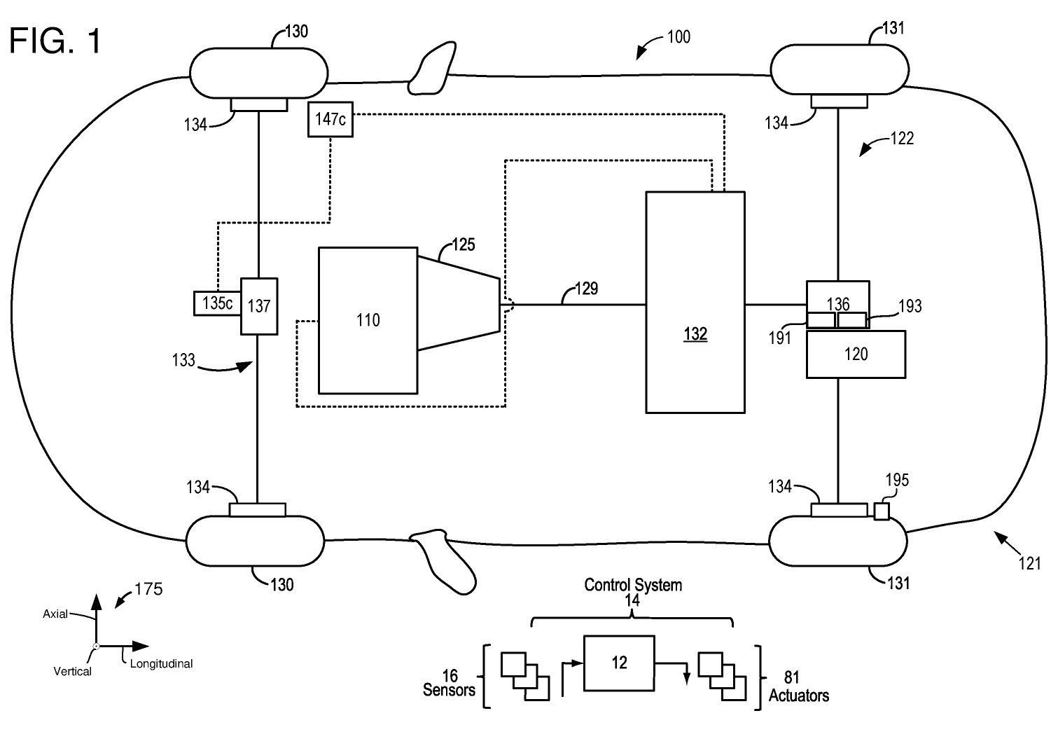

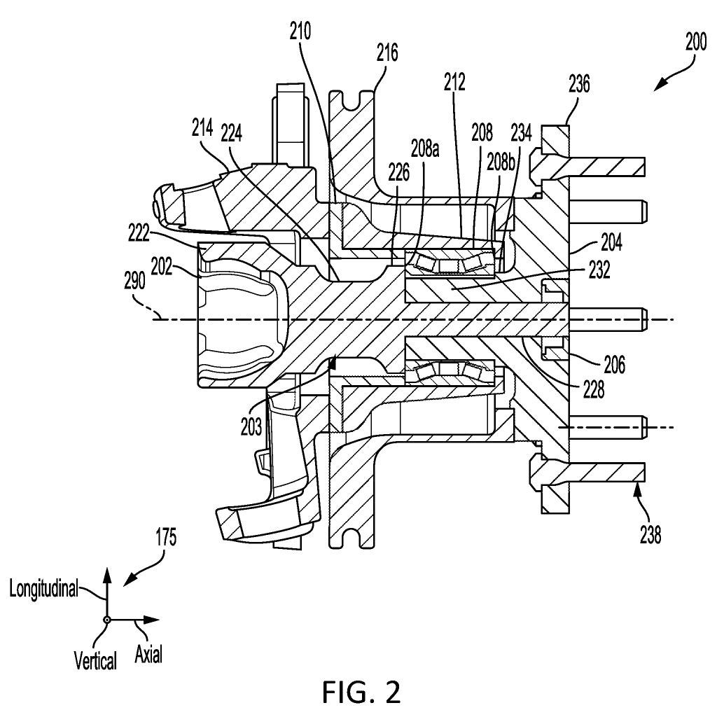

The following description relates to a system for drive axle, and more specifically, a wheel end assembly that may integrated therein. The wheel end assembly may be integrated in a hybrid vehicles architecture as illustrated in FIG. 1. A cross section of the wheel end assembly is depicted in FIG. 2.

In one example, the wheel end assembly includes a constant velocity (CV) shaft that is splined and configured to provide a shoulder, via a CV joint, to contact an inner diameter of a bearing to retain the CV joint. This configuration of the wheel end assembly may not demand a support bearing, which may eliminate a plurality of components, such as a plurality of fasteners, various components for sealing, and a clearance for receiving a socket for servicing the support bearing. An outer surface of a hub includes a shoulder to provide contact between the hub and the inner diameter of the bearing. In this way, the inner diameter of the bearing is retained by the hub and the CV shaft via the CV joint. The bearing retainer is positioned near an end of a bearing housing farthest from a nut that is used in combination with the hub to retain the bearing.

The bearing housing may circumferentially surround the bearing and the bearing retainer. The bearing circumferentially surrounds a portion of the hub such that an inner surface defined by an inner diameter of the bearing is in contact with an outer surface of the hub.

FIG. 1 illustrates an example vehicle propulsion system 100 for a vehicle 121 with a wheel end assembly is integrated therein. Vehicle propulsion system 100 may include at least one power source. In the example of FIG. 1, vehicle propulsion system 100 includes three power sources, including an internal combustion engine 110, an electric machine 120, and an electric machine 135c. However, in other examples, internal combustion engine 110 may be omitted. Further, in other examples, other driveline layouts may be applied. Therefore, it should be appreciated that the system of FIG. 1 is non-limiting. Electric machines 120 and 135c may be configured to utilize or consume a different energy source than internal combustion engine 110. For example, internal combustion engine 110 may consume liquid fuel (e.g. gasoline) to produce an engine power output while electric machines 120 and 135c may consume electrical energy to produce an electric machine power output (e.g., mechanical torque). As such, a vehicle with vehicle propulsion system 100 may be referred to as a hybrid electric vehicle (HEV). In FIG. 1, mechanical connections between various components are illustrated as solid lines, whereas electrical connections between various components are illustrated as dashed lines.

Vehicle propulsion system 100 has a front axle 133 and a rear axle 122. Electric machine 135c may supply mechanical power to differential gears 137 mounted on the front axle 133. Vehicle propulsion system 100 is shown with front wheels 130 coupled to the front axle 133 and rear wheels 131 coupled to the rear axle 122. A wheel end assembly 134 may be interposed between each of the front wheels 130 and each end of the front axle 133. Similarly, the wheel end assembly 134 may be interposed between each of the rear wheels 131 and each end of the rear axle 122 according to the present disclosure. The wheel end assembly 134 is illustrated in greater detail in FIG. 2.

In this example, front wheels 130 may be selectively driven via electric machine 135c and differential gears 137. Wheel end disconnects (not shown) may mechanically decouple front wheels 130 from electric machine 135c and the front axle 133 when vehicle 121 is not operating in a four-wheel drive mode. Further, wheel end disconnects may mechanically couple front wheels 130 to electric machine 135c via the front axle 133 when vehicle 121 is operating in a four-wheel drive mode. An inverter 147c may supply alternating current (AC) to electric machine 135c by converting direct current (DC) power from an energy storage device 132 into AC power. Alternatively, inverter 147c may convert AC power from electric machine 135c into DC power for storage in energy storage device 132. Rear wheels 131 may be driven electrically or via internal combustion engine 110.

The rear axle 122 is coupled to electric machine 120 and to a transmission 125 via a driveshaft 129. The rear axle 122 may be driven either purely electrically and exclusively via electric machine 120 (e.g., electric only drive or propulsion mode, engine is not combusting air and fuel), in a hybrid fashion via electric machine 120 and internal combustion engine 110 (e.g., parallel mode), or exclusively via internal combustion engine 110 (e.g., engine only propulsion mode), in a purely combustion engine-operated fashion. Rear drive unit 136 may transfer power from internal combustion engine 110 or electric machine 120, to rear axle 122, resulting in rotation of rear wheels 131. Rear drive unit 136 may include a gear set, differential 193, and an electrically controlled differential clutch 191 that adjusts torque transfer to rear axle 122.

The transmission 125 is illustrated in FIG. 1 as connected between internal combustion engine 110, and electric machine 120 assigned to rear axle 122. Electric machines 120 and 135a may receive electrical power from onboard energy storage device 132. Furthermore, electric machines 120 and 135a may provide a generator function to convert engine output or the vehicle’s kinetic energy into electrical energy, where the electrical energy may be stored at energy storage device 132 for later use by the electric machine 120, or electric machine 135c. Energy storage device 132 may be a battery, capacitor, inductor, or other electric energy storage device.

In some examples, energy storage device 132 may be configured to store electrical energy that may be supplied to other electrical loads residing on-board the vehicle (other than the motor), including cabin heating and air conditioning, engine starting, headlights, cabin audio and video systems, etc.

A control system 14 may communicate with one or more of internal combustion engine 110, electric machine 120, electric machine 135a, energy storage device 132, transmission 125, wheel end disconnects, etc. Control system 14 may receive sensory feedback information from one or more of internal combustion engine 110, electric machine 120, electric machine 135a, energy storage device 132, transmission 125, etc. Further, control system 14 may send control signals to one or more of internal combustion engine 110, electric machine 120, electric machine 135c, wheel end disconnects, energy storage device 132, transmission 125, etc., responsive to this sensory feedback. Control system 14 may receive an indication of an operator requested output of the vehicle propulsion system from a human operator, or an autonomous controller.

One or more wheel speed sensors (WSS) 195 may be coupled to one or more wheels of vehicle propulsion system 100. The wheel speed sensors may detect a rotational speed of each wheel. Such an example of a WSS may include a permanent magnet type of sensor. A controller 12 may comprise a portion of a control system 14. In some examples, controller 12 may be a single controller of the vehicle. Control system 14 is shown receiving information from a plurality of sensors 16 (various examples of which are described herein) and sending control signals to a plurality of actuators 81 (various examples of which are described herein). As one example, sensors 16 may include wheel speed sensor(s) 195, throttle position sensors (not shown), etc. In some examples, sensors associated with internal combustion engine 110, transmission 125, electric machine 120, wheel speed sensor 195, position sensors that describe the couple/uncouple state of the wheel end disconnect, etc., may communicate information to controller 12, regarding various states of engine, transmission, and electric machine operation. Spatial orientation of vehicle 121 is indicated via axes 175.

FIG. 2 depicts a wheel end assembly 200 integrated in a vehicle, such as the hybrid vehicle architecture described above in FIG. 1. The wheel end assembly 200 may be a non-limiting example of the wheel end assembly 134 of FIG. 1. The wheel end assembly 200 includes a constant velocity (CV) shaft 202, a CV joint 203, a hub 204, a nut 206, a bearing 208, a bearing retainer 210, a bearing housing 212, a knuckle 214, and a rotor 216. The CV shaft 202 may be coupled to the CV joint 203 at one end of the of the CV shaft 202. In one example, the CV shaft 202 is a non-limited example of the front axle 133 and/or the rear axle 122 of FIG. 1

The hub 204 circumferentially surrounds the end of the CV joint 203 of the CV shaft 202 proximal to a wheel. The CV shaft 202 may rotate about an axis 290 that extends through a center of the CV shaft and the CV joint 203. The hub 204 may rotate as the CV joint 203 rotates therein.

The CV shaft 202 may include a splined end that mates with a splined crown 222 of the CV joint 203. The CV shaft 202 may mesh with the splined crown 222 such that when the CV shaft 202 rotates, the splined crown 222 transfers rotational power from the CV shaft 202 to the remainder of the CV joint 203. The splined crown 222 may include a bowl shape or a half-sphere shape.

An intermediate body 224 may extend from the splined crown 222 to shoulder 226. The intermediate body 224 may include a reduced width relative to the splined crown 222 and the shoulder 226, measured along the longitudinal axis. The intermediate body 224 may include recessed sides such that a shape of the intermediate body 224 is similar to an hour glass. That is to say, the intermediate body 224 may include a bilaterally symmetric figure with two wider lobes joined by a narrower constriction at a center. A CV joint rod 228 may extend from the intermediate body 224 and through the hub 204.

The shoulder 226 may extend radially outward relative to the intermediate body 224. The shoulder 226 may extend to a radial position beyond that of an extended section 232 of the hub 204. As such, shoulder 226 may be in face-sharing contact with an inner axial face of each of the hub 204 (e.g., the extended section 232 of the hub 204) and bearing 208. The shoulder 226 may extend less than half way along a radial length of an inner axial face 208a of the bearing 208. The inner axial face 208a may also be in face-sharing contact with the bearing retainer 210. In one example, a gap may be present such that the shoulder 226 and the bearing retainer 210 do not touch. Additionally, or alternatively, the gap may correspond to a section of the inner axial face 208a that is exposed and not in face-sharing contact with the shoulder 226 and the bearing retainer 210.

The bearing 208 may be further supported by the bearing housing 212 and the extended section 232. An inner diameter of the bearing 208 may be in face-sharing contact with the extended section 232 of the hub 204. An outer diameter of the bearing 208 may be in face-sharing contact with the bearing housing 212. In one example, the inner diameter may extend from the portion of the inner axial face 208a in face-sharing contact with the shoulder 226. The outer diameter may extend from the portion of the inner axial face 208a in face-sharing contact with the bearing retainer 210.

In one example, the bearing retainer 210 and the bearing housing 212 are in face-sharing contact. The bearing retainer 210 may include an L-shaped cross-section. The bearing retainer 210 may be a clip, a lock ring, or other similar device, in one example. The bearing retainer 210 may be sandwiched between the bearing housing 212 and the knuckle 214. In one example, the knuckle 214 is a steering knuckle. The rotor 216 is positioned adjacent to the knuckle 214. The rotor 216 is spaced apart from the knuckle 214 such that the inner surface of the rotor 216 is not in contact with the knuckle 214.

The bearing 208 may further include an outer axial face 208b. The outer axial face 208b may be opposite the inner axial face 208a. The inner diameter and the outer diameter of the bearing 208 may extend between the inner axial face 208a and the outer axial face 208b. The outer axial face 208b may be in face sharing contact with each of the bearing housing 212 and a hub shoulder 234. A gap may be present such that the hub shoulder 234 and other portions of the hub 204 do not touch the bearing housing 212. The hub shoulder 234 may extend less than half way along a radial length of the outer axial face 208b of the bearing 208. Similarly, the bearing housing 212 may extend less than half way along the radial length of the outer axial face 208b of the bearing 208. The gap may be arranged proximally to a middle of the outer axial face 208b.

In this way, the bearing 208 may be supported along both axial faces and inner and outer diameters via a combination of the shoulder 226 of the CV joint 203, the bearing retainer 210, the bearing housing 212, the extended section 232 of the hub 204, and the hub shoulder 234. Thus, no adapters, fasteners, and seals are used to support the bearing. Furthermore, the arrangement of the wheel end assembly 200 may eliminate a support bearing and corresponding sealing and service operations. Manufacturing of the wheel end assembly 200 may be simplified due to the use of specialized tools related to the support bearing and its service. Furthermore, additional space may be utilized since clearance for the specialized tools is no longer demanded.

The hub shoulder 234 and extended section 232 may extend to a hub flange 236 of the hub 204. The hub flange 236 may include a plurality of through-holes through which a plurality of fasteners 238 extend. The plurality of fasteners 238 may be configured to physically couple a wheel to the hub 204. The hub flange 236 may extend to a radially outward position beyond an outer diameter of the bearing retainer 210 and the bearing housing 212. The hub flange 236 is in face-sharing contact with the rotor 216.

The nut 206 is configured to thread to the CV joint rod 228 of the CV joint 203 and push against an outer axial surface of the hub 204. The nut 206 physically couples to the CV joint 203. The nut 206 may apply a force against the hub 204, which may apply a threshold force to the bearing 208. By doing this, a retention force applied to the bearing 208 may be set via the nut 206. In one example, outer axial surfaces of the hub 204, the nut 206, and the CV joint 203 are flush with one another adjacent to a location at which a wheel is mounted.

The technical effect of integrating a wheel end assembly wherein a nut is coupled to a CV shaft and pushes against a face side of a hub is that a number of components included in the wheel end assembly may be reduced which may reduce assembly errors and service errors. In particular, the number of components may be reduced due to a support bearing and an adapter between the hub and the CV joint no longer being demanded. The number of components may further be reduced due to sealing components of the support bearing no longer being demanded.

The disclosure also provides support for a wheel end assembly, comprising: a constant velocity (CV) shaft splined with a CV joint that extends through a hub, and a bearing in face-sharing contact with each of a CV joint shoulder and a hub shoulder. In a first example of the system, the CV joint shoulder is in face-sharing contact with an inner axial face of the bearing and the hub shoulder is in face-sharing contact with an outer axial face of the bearing. In a second example of the system, optionally including the first example, the bearing is in further face-sharing contact with a bearing retainer and a bearing housing. In a third example of the system, optionally including one or both of the first and second examples, the bearing retainer is in face-sharing contact with a same side of the bearing as the CV joint shoulder. In a fourth example of the system, optionally including one or more or each of the first through third examples, a gap is between the bearing retainer and the CV joint shoulder on the same side. In a fifth example of the system, optionally including one or more or each of the first through fourth examples, a nut is physically coupled to the CV joint and is configured to apply a pressure against the hub.

The disclosure also provides support for a system for a wheel end assembly, comprising: a bearing arranged between a hub and a bearing housing, a constant velocity (CV) shaft meshed with a CV joint, wherein the CV joint is in face-sharing contact with the bearing and extends through the hub, and a nut that is physically coupled to the CV joint and presses against the hub. In a first example of the system, a CV joint shoulder is in face-sharing contact with an inner axial face of the bearing. In a second example of the system, optionally including the first example, an outer diameter of the bearing is in face-sharing contact with the bearing housing and an inner diameter of the bearing is in face-sharing contact with an extended section of the hub. In a third example of the system, optionally including one or both of the first and second examples, a bearing retainer is in face-sharing contact with the inner axial face, and wherein a gap that exposes a portion of the inner axial face is arranged between the bearing retainer and the CV joint shoulder. In a fourth example of the system, optionally including one or more or each of the first through third examples, the bearing housing and a hub shoulder are in face-sharing contact with an outer axial face of the bearing, and wherein a gap that exposes a portion of the outer axial face is arranged between the bearing housing and the hub shoulder. In a fifth example of the system, optionally including one or more or each of the first through fourth examples, a bearing retainer is sandwiched between a knuckle and the bearing housing. In a sixth example of the system, optionally including one or more or each of the first through fifth examples, the CV joint extends through a central portion of the hub. In a seventh example of the system, optionally including one or more or each of the first through sixth examples, outer axial surfaces of the hub, the nut, and the CV joint are flush with one another. In an eighth example of the system, optionally including one or more or each of the first through seventh examples, a flange of the hub is in face-sharing contact with a rotor and comprises a plurality of fasteners configured to couple to a wheel.

The disclosure also provides support for a wheel end assembly, comprising: a bearing arranged between a hub and a bearing housing, a constant velocity (CV) shaft meshed with a CV joint, wherein a CV joint shoulder is in face-sharing contact with an inner axial face of the bearing and extends through the hub, and wherein a hub shoulder is in face-sharing contact with an outer axial face of the bearing, and a nut that is physically coupled to the CV joint and presses against the hub. In a first example of the system, the hub is in face-sharing contact with an inner diameter of the bearing, the inner diameter extending from the inner axial face to the outer axial face. In a second example of the system, optionally including the first example, the bearing housing is in face-sharing contact with an outer diameter of the bearing, the outer diameter extending from the inner axial face to the outer axial face. In a third example of the system, optionally including one or both of the first and second examples, the CV joint comprises a splined crown that is meshed with the CV shaft. In a fourth example of the system, optionally including one or more or each of the first through third examples, the nut is threaded to a CV joint shaft of the CV joint.

FIG. 2 shows an example configuration with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIG. 2 is shown approximately to scale.

The foregoing description is considered as illustrative only of the principles of the described embodiments. Further, since numerous modifications and changes will readily occur to those skilled in the art, it is not desired to limit the described embodiments to the exact construction and processes shown and described herein. Accordingly, all suitable modifications and equivalents may be considered as falling within the scope of the described embodiments as defined by the claims which follow.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A wheel end assembly, comprising:
a constant velocity (CV) shaft splined with a CV joint that extends through a hub; and
a bearing in face-sharing contact with each of a CV joint shoulder and a hub shoulder.

2. The wheel end assembly of claim 1, wherein the CV joint shoulder is in face-sharing contact with an inner axial face of the bearing and the hub shoulder is in face-sharing contact with an outer axial face of the bearing.

3. The wheel end assembly of claim 1, wherein the bearing is in further face-sharing contact with a bearing retainer and a bearing housing.

4. The wheel end assembly of claim 3, wherein the bearing retainer is in face-sharing contact with a same side of the bearing as the CV joint shoulder.

5. The wheel end assembly of claim 4, wherein a gap is between the bearing retainer and the CV joint shoulder on the same side.

6. The wheel end assembly of claim 1, wherein a nut is physically coupled to the CV joint and is configured to apply a pressure against the hub.

7. A system for a wheel end assembly, comprising:
a bearing arranged between a hub and a bearing housing;
a constant velocity (CV) shaft meshed with a CV joint, wherein the CV joint is in face-sharing contact with the bearing and extends through the hub; and
a nut that is physically coupled to the CV joint and presses against the hub.

8. The system of claim 7, wherein a CV joint shoulder is in face-sharing contact with an inner axial face of the bearing.

9. The system of claim 8, wherein an outer diameter of the bearing is in face-sharing contact with the bearing housing and an inner diameter of the bearing is in face-sharing contact with an extended section of the hub.

10. The system of claim 8, wherein a bearing retainer is in face-sharing contact with the inner axial face, and wherein a gap that exposes a portion of the inner axial face is arranged between the bearing retainer and the CV joint shoulder.

11. The system of claim 8, wherein the bearing housing and a hub shoulder are in face-sharing contact with an outer axial face of the bearing, and wherein a gap that exposes a portion of the outer axial face is arranged between the bearing housing and the hub shoulder.

12. The system of claim 7, wherein a bearing retainer is sandwiched between a knuckle and the bearing housing.

13. The system of claim 7, wherein the CV joint extends through a central portion of the hub.

14. The system of claim 7, wherein outer axial surfaces of the hub, the nut, and the CV joint are flush with one another.

15. The system of claim 7, wherein a flange of the hub is in face-sharing contact with a rotor and comprises a plurality of fasteners configured to couple to a wheel.

16. A wheel end assembly, comprising:
a bearing arranged between a hub and a bearing housing;
a constant velocity (CV) shaft meshed with a CV joint, wherein a CV joint shoulder is in face-sharing contact with an inner axial face of the bearing and extends through the hub, and wherein a hub shoulder is in face-sharing contact with an outer axial face of the bearing; and
a nut that is physically coupled to the CV joint and presses against the hub.

17. The wheel end assembly of claim 16, wherein the hub is in face-sharing contact with an inner diameter of the bearing, the inner diameter extending from the inner axial face to the outer axial face.

18. The wheel end assembly of claim 16, wherein the bearing housing is in face-sharing contact with an outer diameter of the bearing, the outer diameter extending from the inner axial face to the outer axial face.

19. The wheel end assembly of claim 16, wherein the CV joint comprises a splined crown that is meshed with the CV shaft.

20. The wheel end assembly of claim 16, wherein the nut is threaded to a CV joint shaft of the CV joint.
